(19) United States
(12) Patent Application Publication
(10) Pub. No.: US 2012/0222092 A1
(43) Pub. Date: Aug. 30, 2012

(54) CONTROLLING ACCESS TO MEDIA FOR AN ELECTRONIC DEVICE

(75) Inventor: Khosro M. Rabii, San Diego, CA (US)

(73) Assignee: QUALCOMM Incorporated, San Diego, CA (US)

(21) Appl. No.: 13/035,661

(22) Filed: Feb. 25, 2011

(51) Int. Cl. G06F 21/00

(52) U.S. Cl. 726/4

(57) ABSTRACT

An electronic device for controlling access to media is described. The electronic device includes a processor and instructions stored in memory. The electronic device obtains media information and determines remaining battery power. The electronic device also determines whether to restrict access to the media based on the media information and the remaining battery power. The electronic device restricts access to the media if it is determined to restrict access and presents the media on the electronic device if it is determined not to restrict access.

### TECHNICAL FIELD

The present disclosure relates generally to electronic devices. More specifically, the present disclosure relates to controlling access to media for an electronic device.

### BACKGROUND

In the last several decades, the use of electronic devices such as cellular phones, smartphones, handheld gaming systems and other portable electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Recently, the use of networks has also greatly increased. Many electronic devices communicate by using networks. For example, many electronic devices download or stream data from other electronic devices connected to a network. For instance, an electronic device might download a file from a remote server using the Internet. Some electronic devices communicate with networks through a base station. For example, a cellular telephone or smartphone may send information to and/or receive information from a network using a base station. In other words, base stations may relay information between networks and electronic devices.

The increased use of electronic devices and networks has led to greater data access. Many users of electronic devices and networks frequently access data across the network. In some cases, electronic devices may not be able to fully access data across the network, such as multimedia data. This can occur as a result of limited battery power. For example, an electronic device might begin to access (e.g., download, stream, present, etc.) network data, only to have the battery run out of charge. As this discussion illustrates, improved systems and methods for controlling data access may be beneficial.

### SUMMARY

An electronic device for controlling access to media is disclosed. The electronic device includes a processor and instructions stored in memory. The electronic device obtains media information. The electronic device also determines remaining battery power. Furthermore, the electronic device determines whether to restrict access to the media based on the media information and the remaining battery power. The electronic device additionally restricts access to the media if it is determined to restrict access. The electronic device further presents the media on the electronic device if it is determined not to restrict access. The electronic device may also obtain the media if it is determined not to restrict access. The electronic device may also determine a resolution based on the media information and the remaining battery power. The electronic device may be a wireless communication device.

Restricting access to the media may include denying access to the media. Restricting access to the media may include outputting a message indicating that there is not enough remaining battery power to present the media. Restricting access to the media may include denying access to the media unless an authorization is received by the electronic device to present only a part of the media. Restricting access to the media may include denying access to the media unless the electronic device determines to present another version of the media that can be presented in its entirety. It may be determined to restrict access to the media if the media cannot be presented in its entirety on the remaining battery power. It may be determined to restrict access to the media if the media cannot be presented in its entirety on an amount of remaining battery power.

The media may be pay-per-view media. Payment may be required to access the pay-per-view media. The pay-per-view media may be on-demand. The pay-per-view media may be scheduled. The media may include one of a video file, an audio file and an image file.

Obtaining media information may include sending a request for the media information and receiving the media information. The media information may include media complexity. The media information may include media resolution, media size, media duration and media format.

The electronic device may also obtain device information. The device information may include settings, communications, state, performance history, usage history and temperature.

A method for controlling access to media is also disclosed. The method includes obtaining media information. The method also includes determining remaining battery power. The method further includes determining, on an electronic device, whether to restrict access to the media based on the media information and the remaining battery power. The method additionally includes restricting, by the electronic device, access to the media if it is determined to restrict access. The method also includes presenting the media on the electronic device if it is determined not to restrict access.

A computer-program product for controlling access to media is also disclosed. The computer-program product includes a non-transitory tangible computer-readable medium with instructions thereon. The instructions include code for causing an electronic device to obtain media information. The instructions also include code for causing the electronic device to determine remaining battery power. The instructions further include code for causing the electronic device to determine whether to restrict access to the media based on the media information and the remaining battery power. The instructions additionally include code for causing the electronic device to restrict access to the media if it is determined to restrict access. The instructions also include code for causing the electronic device to present the media on the electronic device if it is determined not to restrict access.

An apparatus for controlling access to media is also disclosed. The apparatus includes means for obtaining media information. The apparatus also includes means for determining remaining battery power. The apparatus further includes means for determining whether to restrict access to the media based on the media information and the remaining battery power. The apparatus additionally includes means for restricting access to the media if it is determined to restrict access. The apparatus also includes means for presenting the media on the apparatus if it is determined not to restrict access.

### BRIEF DESCRIPTION OF THE DRAWINGS

FIG. 1 is a block diagram illustrating one configuration of an electronic device in which systems and methods for controlling media access for an electronic device may be implemented;

FIG. 2 is a block diagram illustrating a more specific configuration of an electronic device in which systems and methods for controlling access to media for an electronic device may be implemented;

FIG. 3 is a block diagram illustrating one configuration of a wireless communication device in which systems and methods for controlling access to media for an electronic device may be implemented;

FIG. 4 is a flow diagram illustrating one configuration of a method for controlling access to media for an electronic device;

FIG. 5 is a flow diagram illustrating a more specific configuration of a method for controlling access to media for an electronic device;

FIG. 6 is a block diagram illustrating one configuration of a smartphone in which systems and methods for controlling access to media for an electronic device may be implemented;

FIG. 7 is a block diagram illustrating one configuration of an evaluation module that may be used for controlling access to media for an electronic device;

FIG. 8 is a block diagram illustrating another configuration of an evaluation module that may be used for controlling access to media for an electronic device;

FIG. 9 is a block diagram illustrating another configuration of an evaluation module that may be used for controlling access to media for an electronic device;

FIG. 10 illustrates various components that may be utilized in an electronic device; and

FIG. 11 illustrates certain components that may be included within a wireless communication device.

### DETAILED DESCRIPTION

As used herein, the term “base station” generally denotes a communication device that is capable of providing access to a communications network. Examples of communications networks include, but are not limited to, a telephone network (e.g., a “land-line” network such as the Public-Switched Telephone Network (PSTN) or cellular phone network), the Internet, a Local Area Network (LAN), a Wide Area Network (WAN), a Metropolitan Area Network (MAN), etc. Examples of a base station include cellular telephone base stations or nodes, access points, wireless gateways and wireless routers, for example. A base station may operate in accordance with certain industry standards, such as the Institute of Electrical and Electronics Engineers (IEEE) 802.11a, 802.11b, 802.11g, 802.11n, 802.11ac (e.g., Wireless Fidelity or “Wi-Fi”) standards. Other examples of standards that a base station may comply with include IEEE 802.16 (e.g., Worldwide Interoperability for Microwave Access or “WiMAX”), Third Generation Partnership Project (3GPP), 3GPP Long Term Evolution (LTE) and others (e.g., where a base station may be referred to as a NodeB, evolved NodeB (eNB), etc.). While some of the systems and methods disclosed herein may be described in terms of one or more standards, this should not limit the scope of the disclosure, as the systems and methods may be applicable to many systems and/or standards.

As used herein, the term “wireless communication device” generally denotes a kind of electronic device (e.g., access terminal, client device, client station, etc.) that may wirelessly connect to a base station or other device. A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smartphones, wireless modems, e-readers, tablet devices, gaming systems, music players, Personal Digital Assistants (PDAs), netbooks, etc. Wireless communication devices may operate in accordance with one or more industry standards as described above in connection with base stations. Thus, the general term “wireless communication device” may include wireless communication devices described with varying nomenclatures according to industry standards (e.g., access terminal, user equipment (UE), remote terminal, etc.).

Unlike cable or satellite set-top-box terminals, a mobile platform or electronic device (e.g., wireless communication device) that supports pay-per-view (e.g., pay-TV) services may consider limitations of operating with a battery. Accordingly, in addition to all of the typical criteria considered by a conventional Conditional Access System (CAS) for authenticating and authorizing users to access pay-per-view media (e.g., pay-TV or premium services), a mobile platform or electronic device (e.g., wireless communication device) CAS may also consider available battery reserves (e.g., remaining battery power). These battery reserves may be considered in order to mitigate potential repudiation issues because of battery status. For example, a provider of pay-per-view media may wish to avoid repudiations by customers that claim to have not entirely consumed the pay-per-view media because the battery charge in their wireless communication device ran out during consumption of the pay-per-view media.

In order to remedy such a situation, access to pay-per-view media (e.g., pay-TV or premium services) may be denied when a battery charge is assessed insufficient to present the pay-per-view media in its entirety. Battery status may also be considered for selecting a resolution profile that improves platform workload for successful and complete rendition of the media while reducing or eliminating the possibility of repudiation. This may also be used, for example, in instances where content resolution of premium services can be negotiated with a remote server or where the content is simulcasted in multiple resolutions.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

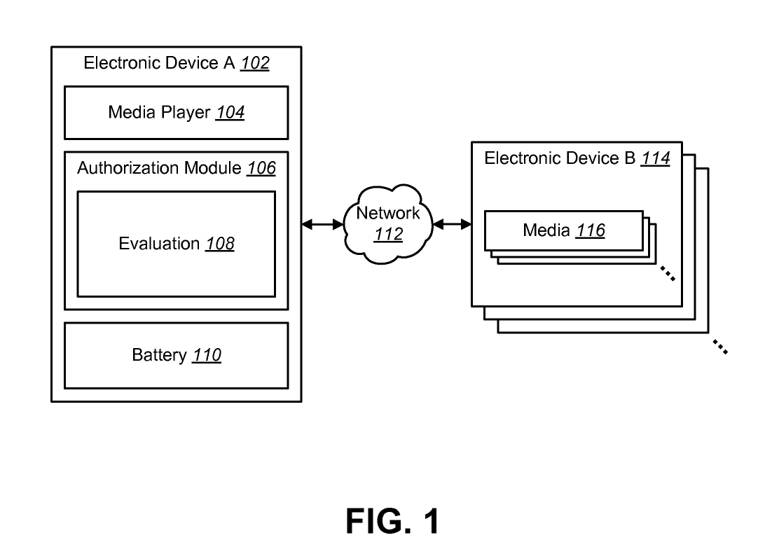

FIG. 1 is a block diagram illustrating one configuration of an electronic device 102 in which systems and methods for controlling media access for an electronic device may be implemented. Examples of electronic device A 102 include cellular phones, smartphones, laptop computers, Personal Digital Assistants (PDAs), handheld or portable gaming systems, netbooks, e-readers and music players (e.g., IPod, Zune, etc.), etc. Electronic device A 102 includes a media player 104, an authorization module 106 and a battery 110. The media player 104 is used to present media 116, such as audio, video and/or images. The media player 104 may be implemented as software, hardware or a combination of both. The authorization module 106 determines whether electronic device A 102 is allowed to access media 116. The authorization module 106 may be implemented as software, hardware or a combination of both. One example of the authorization module 106 is a Conditional Access System (CAS). The battery 110 generally provides power to electronic device A 102.

The term “power” may denote electrical power. For convenience and concision herein, however, the term “power” may additionally or alternatively refer to other measures of electricity, such as current, energy, charge, voltage, current times time, etc. Thus, describing the systems and methods disclosed herein in terms of “power” may make additional or alternative reference to configurations implemented in terms of current, energy, charge, voltage and/or current times time, etc. For example, battery 110 “power” may refer to power, current, energy, charge, voltage and/or current times time, etc., associated with and/or provided by the battery 110. For instance, “remaining battery power” may refer to an amount of milliampere hours (mAh) remaining in a battery.

Electronic device A 102 communicates with one or more electronic devices B 114 using a network 112. Examples of the network 112 include a Local Area Network (LAN), Wide Area Network (WAN), Public Switched Telephone Network (PSTN), the Internet, etc. The one or more electronic devices B 114 include one or more media 116. Examples of the one or more electronic devices B 114 include personal computers, servers, etc. Examples of media 116 include videos, images and/or audio, etc. For instance, the one or more media 116 may include one or more video files, one or more audio files and/or one or more image files that are stored on electronic device B 114. Examples of media 116 include “pay-per-view” media. Pay-per-view media 116 require some form of payment to access the media. As used herein, pay-per-view media 116 include “on-demand” (where the media 116 is provided at the time of request) and/or scheduled media 116 (where the media 116 is provided at a certain scheduled time).

In some cases, electronic device A 102 accesses one or more media 116 by obtaining the media 116 (e.g., streaming, downloading, etc.) and presenting (e.g., playing, displaying, outputting, etc.) the media 116 on the media player 104. In other cases, electronic device A 102 is not allowed to access the media 116. For example, the authorization module 106 may prohibit electronic device A 102 from accessing (e.g., obtaining and presenting) media 116.

The authorization module 106 includes an evaluation module 108. The evaluation module 108 may be implemented as hardware, software or a combination of both. The evaluation module 108 evaluates one or more factors in order to determine whether media 116 can be presented in its entirety on electronic device A 102. In one configuration, the evaluation module 108 evaluates whether the media 116 can be obtained and/or presented in its entirety based on the amount of battery 110 power remaining. For instance, the evaluation module 108 may compute an amount of battery 110 power needed to present a video in its entirety on electronic device A 102 based on media 116 complexity, size (e.g., in bits, Bytes, etc.), resolution, frame rate, bit rate and/or duration, etc. This amount of battery 110 power needed may be compared to remaining battery 110 power to determine if the media 116 can be entirely presented within the amount of remaining battery 110 power or a lesser amount, for example.

According to the systems and methods disclosed herein, the authorization module 106 may restrict electronic device A 102 from accessing the media 116. For example, if electronic device A 102 does not have sufficient battery 110 power to present a media 116 file in its entirety (as determined by the evaluation module 108), the authorization module 106 restricts or prevents electronic device A 102 from accessing the media.

An example illustrating one way that the systems and methods disclosed herein may be beneficial follows. For example, assume that user A of an electronic device desires to watch a pay-per-view boxing match. User A selects the boxing match on the electronic device, which is provided to the electronic device for a $40 charge to his account. However, halfway through the first round, the battery in user A's electronic device runs out of charge and the electronic device shuts down. The user then repudiates the charge for the boxing match, claiming that he was unable to watch the entire boxing match because the battery ran out of charge. Assume that user B of another electronic device selects the same boxing match for the same $40 charge. In this case, however, user B watches the boxing match in its entirety. User B does not like the additional $40 charge on his bill, so he repudiates the charge, dishonestly alleging that he also was unable to watch the entire match because the battery on his electronic device ran out. In these cases, a pay-per-view provider may not be able to dispute the repudiation.

Continuing with the example, assume that user A purchases electronic device A 102, including the evaluation module 108. User A desires to watch a pay-per-view boxing match while electronic device A 102 has low battery 110. The evaluation module 108 determines that not enough charge is remaining in the battery 110 to present the entire boxing match on the media player 104. Electronic device A 102 restricts access to the boxing match, possibly notifying user A that not enough battery 110 charge remains to present the boxing match. User A may then charge the battery 110 to be able to watch the boxing match or abandon watching the boxing match. Assume that user B purchases electronic device A 102, including the evaluation module 108. Assume that user B watches another pay-per-view boxing match in its entirety and again dishonestly repudiates the $40 charge. In this case, the pay-per-view provider may successfully dispute the repudiation, since the evaluation module 108 determined before the boxing match was purchased that the battery 110 had sufficient power or charge remaining to display the boxing match on the media player 104.

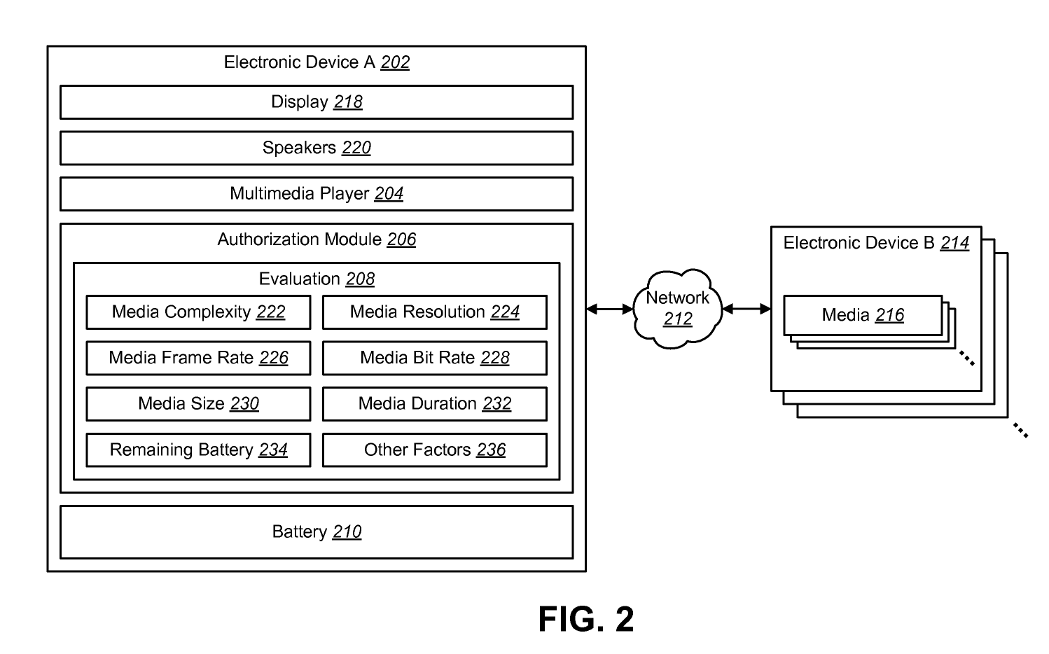

FIG. 2 is a block diagram illustrating a more specific configuration of an electronic device 202 in which systems and methods for controlling access to media for an electronic device may be implemented. In the configuration illustrated in FIG. 2, electronic device A 202 includes a display 218, one or more speakers 220, a multimedia player 204, an authorization module 206 and a battery 210. Electronic device A 202 communicates with one or more electronic devices B 214 using a network 212. The one or more electronic devices B 214 include one or more media 216, such as videos, images and/or audio (e.g., video files, image files and/or audio files), etc. In some cases, the one or more electronic devices B 214 provide the one or more media 216 to electronic device A 202.

When the media 216 is provided by one or more electronic devices B 214, electronic device A 202 presents the media 216 using the multimedia player 204. The multimedia player 204 may be implemented as hardware, software, or a combination of both. The media 216 may be presented using the display 218 and/or speakers 220. For example, video is presented by displaying images on the display 218 and/or outputting sound from the speakers 220, audio is presented by outputting sound from the speakers 220 and images are displayed on the display 218.

The authorization module 206 controls electronic device A's 202 access to the media 216. In one configuration, the authorization module 206 uses data such as account history, payment history, parental controls, type of subscription and/or other data to control electronic device A's access to the media 216. For example, the authorization module 206 may deny electronic device A's 202 access to the media 216 if a prior bill hasn't been paid or if a correct password is not entered.

The authorization module 206 includes an evaluation module 208, which it 206 may additionally or alternatively use to control access to the media 216 based on remaining battery 210 power. In the configuration illustrated in FIG. 2, the evaluation module 208 includes information such as media complexity 222, media resolution 224, media frame rate 226, media bit rate 228, media size 230, media duration 232, remaining battery power 234 and/or other factors 236.

Media complexity 222 relates to the amount of processing needed to present the media 216. For example, media complexity 222 may indicate a codec used to encode and/or decode the media 216. Different codecs may require different amounts of processing to decode and/or present media. Media resolution 224 indicates the resolution of the media 216. For example, media resolution 224 may indicate a number of pixels and/or a pixel density for video or images. For instance, media resolution 224 may indicate whether a video is in High Definition (HD) (e.g., 1,920×1,080 pixels (1080p or 1080i), 1,280×720 pixels (720p), etc.) or Standard Definition (SD) (e.g., 480i). Media frame rate 226 indicates the frame rate of the media 216. For example, media frame rate 226 indicates a number of image frames per second in video. Media bit rate 228 is the bit rate of the media 216. For example, the media bit rate 226 indicates the number of bits per unit of playback time for audio or video. The media size 230 is the size of the media 216 (in bits or Bytes, for example). For example, media size 230 indicates the size of the media 216 (e.g., audio, video and/or image files) in a number of bits or Bytes. The media duration 232 indicates the duration of the media 216 (e.g., in time). For example, the media duration 232 indicates the amount of playback time (e.g., in hours, minutes, seconds, etc.) of audio or video. The term “media information” may be used herein to collectively refer to information relating to the media 216. In the configuration illustrated in FIG. 2, for example, “media information” may include one or more of media complexity 222, media resolution 224, media frame rate 226, media bit rate 228, media size 230, media duration 232 and/or other factors 236 relating to the media 216. The term “device information” may be used herein to collectively refer to one or more pieces of information relating to electronic device A 202, such as remaining battery 234 and/or other factors 236 relating to electronic device A 202 (e.g., settings, communications, state, performance history, usage history, temperature, etc.).

Electronic device A 202 may obtain the information in the evaluation module 208 locally (e.g., from electronic device A 202) and/or from another electronic device on the network 212. In one configuration, electronic device A 202 periodically receives information about the media 216. For instance, electronic device A 202 may periodically download and store playlists and media 216 metadata (including some or all of the media information 222, 224, 226, 228, 230, 232, 236) from electronic device B 214 or from another electronic device on the network 212. In another configuration, electronic device A 202 requests and/or receives information (e.g., some or all of the media information 222, 224, 226, 228, 230, 232, 236) from electronic device B 214 or from another electronic device on the network 212 about the media 216. Electronic device A 202 may also obtain information regarding remaining battery power 234. For example, electronic device A 202 requests a measurement of remaining battery power 234 from a Power Management Device (PMD) (not shown) included on electronic device A 202. Other factors 236 may be obtained, including factors such as media format, settings, communications, state, performance history, usage history and temperature, for example. More detail on these other factors is given hereafter.

It should be noted that remaining battery 234 “power” may be characterized, quantified or measured by specific gravity, power in watts (W), charge in coulombs (C) or milliampere-hours (mAh), energy in watt-hours (Wh), voltage in volts (V), amperage in amperes (A), etc. Three more specific examples of approaches used to measure a battery's 234 state of charge may include by specific gravity, by voltage and by ampere-hours. Using specific gravity may be an accurate approach. However, this approach may be “messy” and may require special instrumentation. Although a specific gravity approach could be used, it is not commonly used in mobile electronics. Measuring battery 234 charge by voltage may be less accurate. However, it may require minimal infrastructure and a-priori knowledge of how the battery 234 voltage degrades with use. In one configuration, a Digital-to-Analog Converter (DAC) for sensing battery 234 voltage and a look-up table may be used to measure battery 234 charge using voltage. Measuring battery 234 charge by ampere-hours may provide a good approach to measuring state of charge, both in terms of accuracy and ease of use. This approach may be used by tracking the current that the battery 234 has delivered while in use.

The evaluation module 208 uses one or more pieces of information to determine whether electronic device A 202 can present media 216 (e.g., a video, a song, one or more images, etc.) in its entirety on the remaining battery power 234 or a portion of the remaining battery power 234. For example, the evaluation module 208 uses media complexity 222, media resolution 224, media frame rate 226, media bit rate 228, media size 230, media duration 232 and/or other factors 236 to compute a presentation cost. The presentation cost indicates an amount or estimate of battery 210 power required to obtain and/or present the media 216. In one configuration, the evaluation module 208 compares the presentation cost to the remaining battery power 234. If the amount or estimate of battery 210 power required to obtain and/or present the media 216 is greater than the remaining battery power 234 or an amount of remaining battery power 234, the evaluation module 208 determines that the media 216 cannot be obtained and/or presented in its entirety on the remaining battery power 234.

The authorization module 206 uses the determination made by the evaluation module 208 to control electronic device A's 202 access to the media 216. In one configuration, the authorization module 206 restricts electronic device A's 202 access to the media 216 when the evaluation module 208 determines that there is not enough remaining battery power 234 to present the media 216 in its entirety. In one configuration, the authorization module 206 restricts electronic device A's 202 access to the media 216 by denying access to the media 216 (e.g., not allowing electronic device A 202 to download, stream and/or present the media 216). In other configurations, the authorization module 206 restricts access to the media 216 by additionally or alternatively notifying the user that there is not enough remaining battery 234 to present the media 216, denying access to the media 216 unless it receives specific authorization to present only a part of the media 216 (at a full or reduced pay-per-view price, for example) and/or denying access to the media 216 unless it 202 receives an instruction and/or determines to present another version of the media 216 (e.g., lower resolution 224, lower complexity 222, etc.) that can be obtained and/or presented in its entirety.

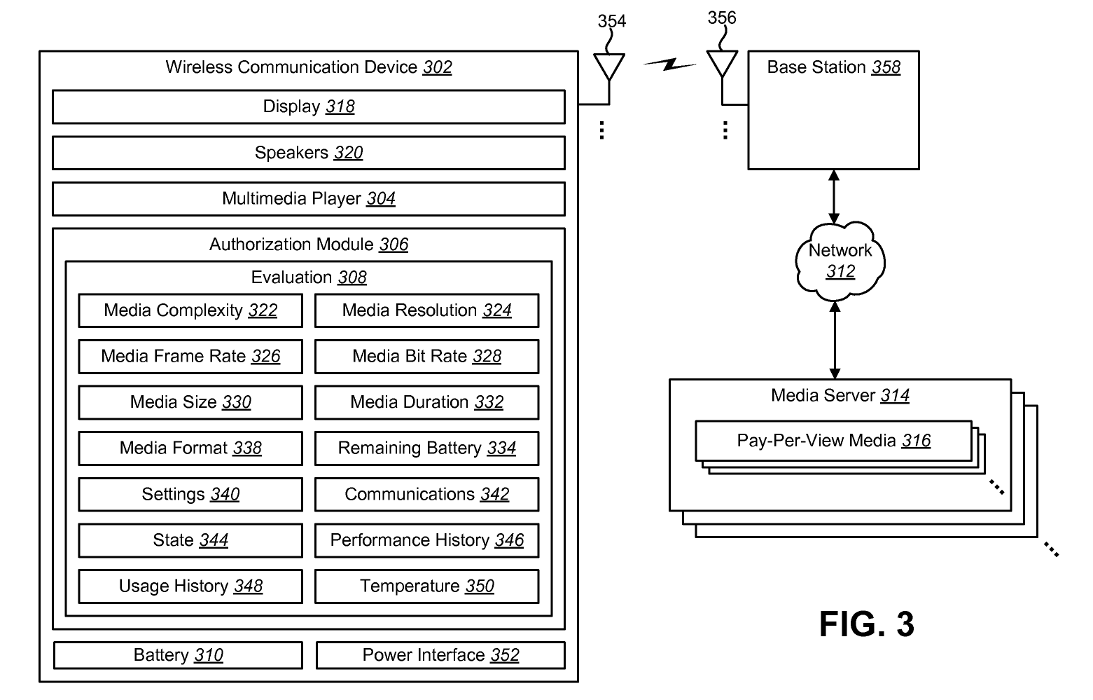

FIG. 3 is a block diagram illustrating one configuration of a wireless communication device 302 in which systems and methods for controlling access to media for an electronic device may be implemented. Examples of wireless communication devices 302 include cellular phones, smartphones, laptop computers, e-readers, Personal Digital Assistants (PDAs), tablet devices, netbooks, audio players (e.g., iPods, Zunes, etc.), etc. In the configuration illustrated in FIG. 3, the wireless communication device 302 includes a display 318, one or more speakers 320, a multimedia player 304, an authorization module 306, a battery 310, a power interface 352 and one or more antennas 354. The battery 310 generally provides power to the wireless communication device 302. The power interface 352 may be used to charge the battery 310. For example, the power interface 352 may include a port that allows the wireless communication device 302 to be connected to an external power source (e.g., wall outlet, car power adapter, etc.). The battery 310 may be charged or charging when the power interface 352 is connected to an external power source.

The wireless communication device 302 communicates with one or more media servers 314 using a base station 358 and a network 312. In one configuration, the wireless communication device 302 uses one or more antennas 354 to transmit and receive electromagnetic signals. The base station 358 may receive the signals from the wireless communication device 302 using one or more antennas 356. The base station 358 may also transmit electromagnetic signals using its one or more antennas 356 that are received by the wireless communication device 302 using its one or more antennas 354. The base station 358 may use signals received from the wireless communication device 302 to communicate with the one or more media servers 314 using the network 312. Examples of base stations 358 include cellular phone base stations, wireless routers, wireless gateways, etc.

The one or more media servers 314 include one or more pay-per-view media 316, such as videos, images and/or audio (e.g., video files, image files and/or audio files), etc. A cost or payment is typically incurred (e.g., a user's account is charged) to access the pay-per-view media 316. In one configuration, a user's account is automatically charged when pay-per-view media 316 is accessed by the wireless communication device 302. For example, pay-per-view media 316 includes media such as sporting events (e.g., boxing, fighting, soccer, basketball, football, etc.), movies, images (e.g., photographs, artwork, etc.) and/or music, etc. In some cases, the one or more media servers 314 provide the one or more pay-per-view media 316 to the wireless communication device 302. For example, the one or more media servers 314 may provide the pay-per-view media 316 (at a price, for example) to the wireless communication device 302 when the authorization module 306 approves (e.g., sends a message or notifies the one or more media servers 314 that the wireless communication device 302 is permitted to access the pay-per-view media 316).

When the pay-per-view media 316 is provided by the one or more media servers 314, the wireless communication device 302 presents the pay-per-view media 316 using the multimedia player 304. The multimedia player 304 may be implemented as hardware, software, or a combination of both. The pay-per-view media 316 may be presented using the display 318 and/or speakers 320. For example, video is presented by displaying images on the display 318 and/or outputting sound from the speakers 320, audio is presented by outputting sound from the speakers 320 and images are displayed on the display 318. The speakers 320 may be built-in speakers or may be removable, as a pair of headphones, for example.

The authorization module 306 controls the wireless communication device's 302 access to the media. In one configuration, the authorization module 306 uses data such as account history, payment history, parental controls, type of subscription and/or other data to control the wireless communication device's 302 access to the media 316. For example, the authorization module 306 may deny the wireless communication device's 302 access to the pay-per-view media 316 if a prior bill hasn't been paid or if a correct password is not entered.

The authorization module 306 includes an evaluation module 308, which it 306 may use to control access to the pay-per-view media 316 based on remaining battery 310 power. In the configuration illustrated in FIG. 3, the evaluation module 308 includes information such as media complexity 322, media resolution 324, media frame rate 326, media bit rate 328, media size 330, media duration 332, media format 338, remaining battery power 334, settings 340, communications 342, state 344, performance history 346, usage history 348 and/or temperature 350.

Media complexity 322 relates to the amount of processing needed to present the pay-per-view media 316. For example, media complexity 322 may indicate a codec used to encode and/or decode the pay-per-view media 316. Media resolution 324 indicates the resolution of the pay-per-view media 316. For example, media resolution 324 may indicate a number of pixels and/or a pixel density for video or images. For instance, media resolution 324 may indicate whether a video is in High Definition (HD) (e.g., 1,920×1,080 pixels (1080p or 1080i), 1,280×720 pixels (720p), etc.) or Standard Definition (SD) (e.g., 480i). Media frame rate 326 indicates the frame rate of the pay-per-view media 316. For example, media frame rate 326 indicates a number of image frames per second in video. Media bit rate 328 is the bit rate of the pay-per-view media 316. For example, the media bit rate 328 indicates the number of bits per unit of playback time for audio or video.

Media size 330 is the size of the pay-per-view media 316 (in bits or Bytes, for example). For example, media size 330 indicates the size of the pay-per-view media 316 (e.g., audio, video and/or image files) in a number of bits or Bytes. The media duration 332 indicates the duration of the pay-per-view media 316 (e.g., in time). For example, the media duration 332 indicates the amount of playback time (e.g., in hours, minutes, seconds, etc.) of audio or video. The media format 338 indicates the data or file format of the pay-per-view media 316. For example, the media format 338 may indicate that the pay-per-view media 316 is formatted as a Windows Media Video (WMV) file, Moving Picture Experts Group Audio Layer 3 (mp3) file, Joint Photographic Experts Group (JPEG or jpg) file, etc. It should be noted that one or more of the media complexity 322, media resolution 324, media frame rate 326, media bit rate 328, media size 330, media duration 332 and/or media format 338 may be collectively referred to herein as “media information.”

The remaining battery 334 indicates the amount of remaining battery 310 power or charge, for example. The settings 340 indicate one or more wireless communication device 302 settings. Some examples of settings 340 include display 318 brightness, speaker 320 volume and/or other wireless communication device 302 settings that may affect battery 310 performance (e.g., discharge rate). Communications 342 indicate the communication configuration of the wireless communication device 302. For example, communications 342 may indicate the amount of amplification or gain being provided to transmitted and/or received signals, the type of modulation being used for reception and/or transmission, the type of channel coding and/or decoding being used and/or received signal strength, etc. Communications 342 may be used, for example, to determine an amount of battery 310 power needed to receive the pay-per-view media 316.

The state 344 of the wireless communication device 302 may include information about the behavior or status of the wireless communication device 302. For example, the state 344 may indicate whether the wireless communication device 302 is multitasking (e.g., running multiple applications at the same time), which applications or operations the wireless communication device 302 is performing (e.g., whether it 302 is currently performing a phone call, running a game application, receiving Global Positioning Satellite (GPS) data for a map application, etc) and/or whether the wireless communication device 302 is currently charging (e.g., plugged into a wall outlet) via the power interface 352. In one configuration, if the state 344 indicates that wireless communication device 302 is connected to an external power source, the evaluation module 308 determines that the pay-per-view media 316 can be presented in its entirety.

The performance history 346 indicates one or more aspects of wireless communication device 302 performance. For example, performance history 346 may indicate a historical rate of battery 310 power consumption in different states or modes of use, such as while downloading a pay-per-view media 316 file, while presenting a certain type of media, while running a particular application, while in standby, while at a particular temperature, etc.

Usage history 348 includes historical usage information. For example, usage history 348 may indicate how frequently the wireless communication device 302 runs multiple applications at the same time, which applications are typically run, how frequently the pay-per-view media 316 presentations are paused, when the wireless communication device 302 tends to receive calls, etc. The temperature 350 indicates the temperature of the wireless communication device 302 (in degrees Fahrenheit and/or Celsius, etc.). It should be noted that one or more of remaining battery 334, settings 340, communications 342, state 344, performance history 346, usage history 348 and/or temperature 350 may be collectively referred to herein as “device information.”

It should be noted that one or more of the media information factors 322, 324, 326, 328, 330, 332, 338 and one or more of the device information factors 334, 340, 342, 344, 346, 348, 350 may impact or give an indication of battery 310 performance. For example, the battery 310 may discharge at a particular rate or provide an amount of power during receiving pay-per-view media 316 and/or presenting pay-per-view media 316. One or more of these factors 322, 324, 326, 328, 330, 332, 338, 334, 340, 342, 344, 346, 348, 350 may be used to determine or project the amount of power or charge from the battery 310 that is needed to receive and/or present a piece of pay-per-view media 316.

The wireless communication device 302 may obtain the information in the evaluation module 308 locally (e.g., from the wireless communication device 302) and/or from another electronic device on the network 312. In one configuration, the wireless communication device 302 periodically receives information about the pay-per-view media 316. For instance, the wireless communication device 302 may periodically download and store (e.g., in memory) playlists and pay-per-view media 316 metadata (including some or all of the media information 322, 324, 326, 328, 330, 332, 338) from the media server 314 or from another electronic device on the network 312. In another configuration, the wireless communication device 302 requests and/or receives information (e.g., some or all of the media information 322, 324, 326, 328, 330, 332, 338) from the media server 314 or from another electronic device on the network 312 about the pay-per-view media 316.

The wireless communication device 302 may also obtain information (e.g., device information 334, 340, 342, 344, 346, 348, 350) relating to the wireless communication device 302. For example, the wireless communication device 302 requests a measurement of remaining battery power 334 from a Power Management Device (PMD) (not shown) included on the wireless communication device 302. Remaining battery 334 may be characterized, quantified or measured as power in watts (W), charge in coulombs (C) or milliampere-hours (mAh), energy in watt-hours (Wh), voltage in volts (V), amperage in amperes (A), etc. Settings 340, communications 342, state 344, performance history 346, usage history 348 and/or temperature 350 may be obtained, for example, by querying an Operating System (OS), sensors and/or records (for performance history 346 and/or usage history 348, for example) on the wireless communication device 302.

The evaluation module 308 uses one or more pieces of information (e.g., media information and/or device information) to determine whether the wireless communication device 302 can obtain and/or present pay-per-view media 316 (e.g., a video, a song, one or more images, etc.) in its entirety on the remaining battery 310 power or a portion of the remaining battery 310 power. For example, the evaluation module 308 uses media complexity 322, media resolution 324, media frame rate 326, media bit rate 328, media size 330, media duration 332, media format 338, remaining battery 334, settings 340, communications 342, state 344, performance history 346, usage history 348, and/or temperature 350 to compute a presentation cost. The presentation cost indicates an amount or estimate of battery 310 power required to obtain and/or present the pay-per-view media 316. In one configuration, the evaluation module 308 compares the presentation cost to the remaining battery power 334. If the amount or estimate of battery 310 power required to obtain and/or present the pay-per-view media 316 is greater than the remaining battery power 334 or an amount of remaining battery power 334, the evaluation module 308 determines that the pay-per-view media 316 cannot be obtained and/or presented in its entirety on the remaining battery power 334.

The authorization module 306 uses the determination made by the evaluation module 308 to control the wireless communication device's 302 access to pay-per-view media 316. In one configuration, the authorization module 306 restricts the wireless communication device's 302 access to the pay-per-view media 316 when the evaluation module 308 determines that there is not enough remaining battery power 334 to present the pay-per-view media 316 in its entirety. In one configuration, the authorization module 306 restricts the wireless communication device's 302 access to the pay-per-view media 316 by denying access to the pay-per-view media 316 (e.g., not allowing the wireless communication device 302 to download, stream and/or present the pay-per-view media 316). In other configurations, the authorization module 306 restricts access to the pay-per-view media 316 by additionally or alternatively notifying the user that there is not enough remaining battery 334 to present the pay-per-view media 316, denying access to the pay-per-view media 316 unless it receives specific authorization to present only a part of the pay-per-view media 316 (at a full or reduced pay-per-view price, for example) and/or denying access to the pay-per-view media 316 unless it 302 receives an instruction and/or determines to present another version of the pay-per-view media 316 (e.g., lower resolution 324, lower complexity 322, etc.) that can be obtained and/or presented in its entirety.

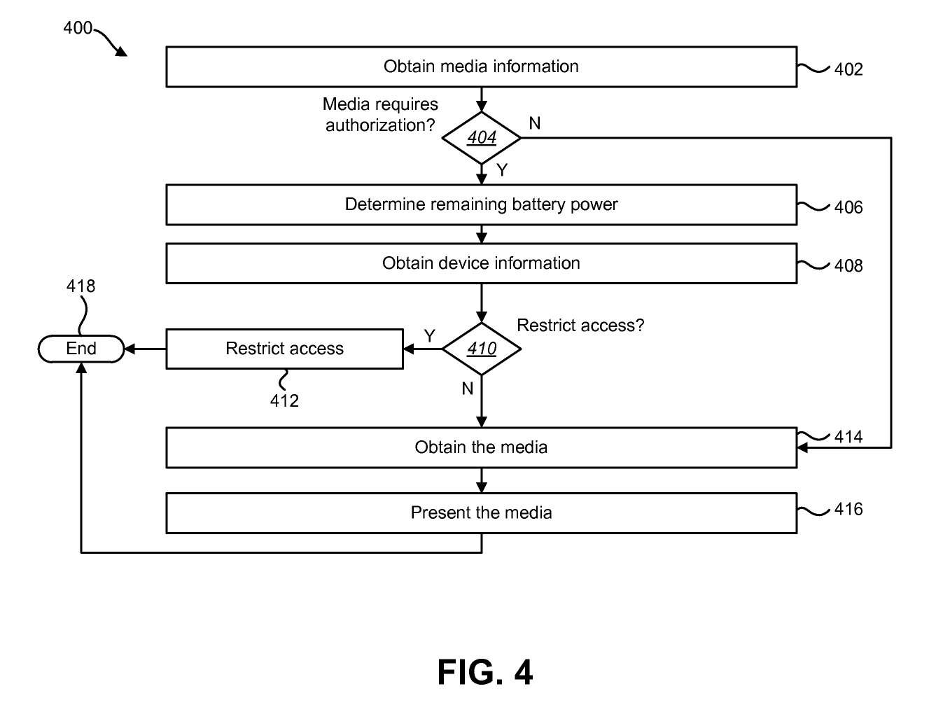

FIG. 4 is a flow diagram illustrating one configuration of a method 400 for controlling access to media for an electronic device. An electronic device 102 may obtain 402 media information. For example, the electronic device 102 may request and receive media information from another electronic device (e.g., electronic device B 114 or some other electronic device on the network 112) and/or may retrieve the media information from memory (if the media information has been previously obtained or downloaded, etc.). Examples of media information include media complexity 322, media resolution 324, media frame rate 326, media bit rate 328, media size 330, media duration 332 and/or media format 338. The electronic device 102 may determine 404 whether the media requires authorization to access (e.g., obtain and/or present). For example, the electronic device 102 may determine that the media is pay-per-view media that requires authorization. For instance, pay-per-view media 316 may require authorization from an authorization module 106 before the electronic device 102 is allowed to access the pay-per-view media 316.

If the electronic device 102 determines 404 that the media does not require authorization, the electronic device 102 may obtain 414 the media. For example, the electronic device 102 may stream or download the media 116 from electronic device B 114 using the network 112. The electronic device 102 may present 416 the media 116. For example, the electronic device 102 may display the media 116 (e.g., for videos, images, etc.) on a display on the electronic device 102. The electronic device 102 may additionally or alternatively output an acoustic signal (e.g., for audio, sounds, music, etc.) using speakers on or headphones attached to the electronic device 102, for example. It should be noted that in order for the media 116 to be presented 416, the media 116 may be decoded for playback, for example.

If the electronic device 102 determines 404 that the media requires authorization (e.g., the media is pay-per-view media 316), the electronic device 102 determines 406 remaining battery power. For example, the electronic device 102 may use a Power Management Device (PMD) to determine 406 the remaining battery power. For instance, the electronic device 102 (e.g., authorization 206 or evaluation module 208) requests and/or receives a measurement of or information about remaining battery 234 (e.g., power, charge, etc.) from the PMD.

The electronic device 102 may obtain 408 device information. For example, the electronic device 102 may obtain 408 (additional) device information such as settings 340, communications 342, state 344, performance history 346, usage history 348 and/or temperature 350. The electronic device 102 may obtain 408 this device information by requesting and/or receiving it from the Operating System (OS), sensors and/or memory of the electronic device 102, for example.

The electronic device 102 determines 410 whether to restrict access to the media 116. This determination 410 may be based on the media information, remaining battery power and/or additional device information. For example, the electronic device 102 (e.g., evaluation module 108) may evaluate the media information, remaining battery power and/or additional device information to determine whether the media 116 can be obtained and/or presented in its 116 entirety using the remaining battery power or a portion of the remaining battery power. In one configuration, the electronic device 102 (e.g., authorization module 106) determines 410 to restrict access to the media 116 if the media 116 cannot be obtained and/or presented in its entirety with the remaining battery power or a portion of the remaining battery power. The portion of remaining battery power may be a percentage of battery power (of battery capacity or of remaining power/charge, for example) or a portion that allows a certain amount of battery power or charge remaining before complete discharge, for example. For instance, the electronic communication device 102 may preserve at least a set number of milliamp hours (mAh) in the battery after presenting any media 116.

In one configuration, the electronic device 102 uses one or more of media complexity 222, media resolution 224, media frame rate 226, media bit rate 228, media size 230, media duration 232, remaining battery 234 and/or other factors 236 to determine whether the media 216 can be obtained and/or presented in its entirety using the remaining battery 234 power. For instance, the electronic device 102 (e.g., evaluation module 108) uses one or more of these factors to compute a presentation cost or presentation cost estimate and compares it to the remaining battery power 234, determining whether the presentation cost or estimate is greater than the remaining battery power 234 or a portion of remaining battery power 234. If the presentation cost or estimate is greater than the remaining battery power 234 or a portion thereof, the electronic device 102 determines 410 to restrict media access.

If the electronic device 102 determines 410 to restrict access, the electronic device 102 restricts 412 access. In one configuration, the electronic device 102 (e.g., authorization module 106) restricts 412 access by denying access to the media 116. For example, the electronic device 102 does not stream, download and/or present the media 116. In other configurations, the electronic device 102 (e.g., authorization module 106) restricts 412 access to the media 116 by additionally or alternatively outputting (e.g., displaying, outputting an acoustic signal, etc.) a message (to notify a user, for example) that there is not enough remaining battery to present the media 116, denying access to the media 116 unless it 102 receives specific authorization to present only a part of the media 116 (at a full or reduced pay-per-view price, for example) and/or denying access to the media 116 unless it 102 receives an instruction and/or determines to present another version of the media 116 (e.g., lower resolution, lower complexity, etc.) that can be presented in its entirety. In one configuration, operation ends 418 after restricting 412 access.

If the electronic device 102 determines 410 not to restrict access (when the media 116 can be obtained and/or presented in its entirety on the remaining battery 110 power or a portion thereof, for example), the electronic device 102 obtains 414 the media 116. For example, the electronic device 102 may stream or download the media 116 from electronic device B 114 using the network 112. The electronic device 102 may present 416 the media 116. For example, the electronic device 102 may display the media 116 (e.g., for videos, images, etc.) on a display on the electronic device 102. The electronic device 102 may additionally or alternatively output an acoustic signal (e.g., for audio, sounds, music, etc.) using speakers included in or headphones attached to the electronic device 102, for example. It should be noted that in order for the media 116 to be presented 416, the media 116 may be decoded for playback, for example. In one configuration, operation ends 418 after presenting 416 the media.

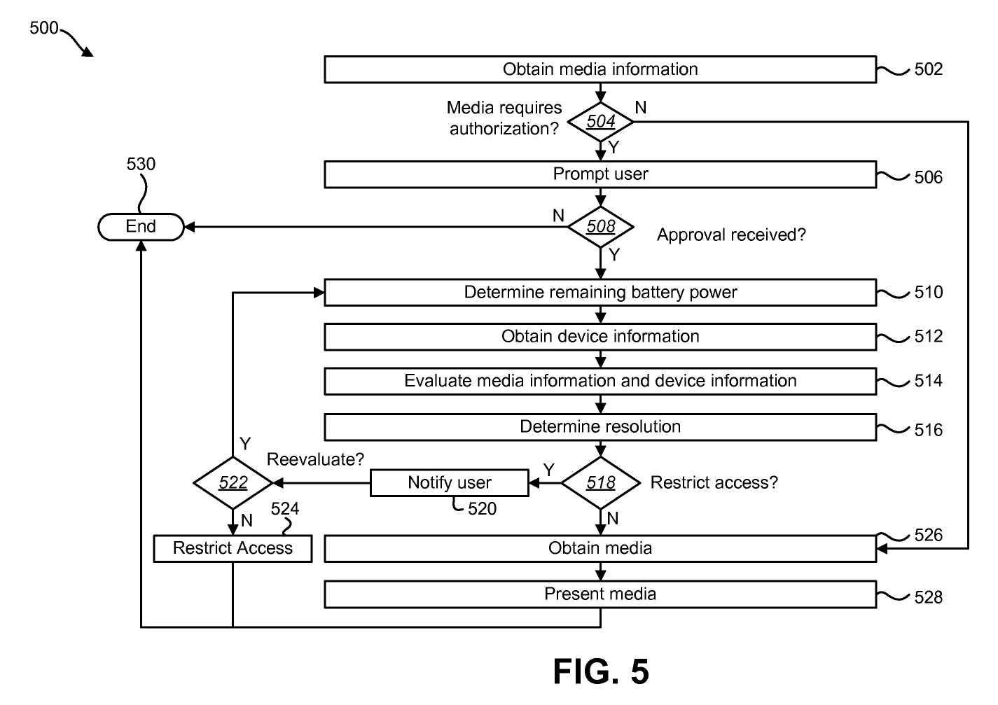

FIG. 5 is a flow diagram illustrating a more specific configuration of a method 500 for controlling access to media for an electronic device. An electronic device 102 may obtain 502 media information. For example, the electronic device 102 may request and receive media information from another electronic device (e.g., electronic device B 114 or some other electronic device on the network 112) and/or may retrieve the media information from memory (if the media information has been previously obtained or downloaded, etc.). Examples of media information include media complexity 322, media resolution 324, media frame rate 326, media bit rate 328, media size 330, media duration 332 and/or media format 338, etc.

The electronic device 102 may determine 504 whether the media 116 requires authorization to access (e.g., download and/or present) it. For instance, pay-per-view media 116 may require authorization from an authorization module 106 before the electronic device 102 is allowed to access the pay-per-view media 116. In one configuration, the electronic device 102 determines that the media 116 requires authorization based on the media information (e.g., media format 338, etc.). In another configuration, the electronic device 102 determines that the media 116 requires authorization by requesting and/or receiving an indication that the media 116 requires authorization from another electronic device (e.g., electronic device B 114 or some other electronic device on the network 112). In another configuration, the electronic device 102 determines 504 whether the media 116 requires authorization based on the source (e.g., Internet Protocol (IP) address, network address, etc.) of the media 116.

If the electronic device 102 determines 504 that the media does not require authorization, the electronic device 102 may obtain 526 the media. For example, the electronic device 102 may stream or download the media 116 from electronic device B 114 using the network 112. The electronic device 102 may present 528 the media 116. For example, the electronic device 102 may display the media 116 (e.g., for videos, images, etc.) on a display on the electronic device 102. The electronic device 102 may additionally or alternatively output an acoustic signal (e.g., for audio, sounds, music, etc.) using speakers on or headphones attached to the electronic device 102, for example. It should be noted that in order for the media 116 to be presented 528, the media 116 may be decoded for playback, for example.

If the electronic device 102 determines 504 that the media requires authorization (e.g., the media is pay-per-view media 316), the electronic device 102 may prompt 506 a user. For example, the electronic device 102 may display or output a message indicating that the media 116 requires authorization. This message may additionally or alternatively indicate that the media is pay-per-view media 316 and that a charge will be assessed to an account if the media is accessed. One or more of these messages may be used to prompt 506 a user.

The electronic device 102 may determine 508 whether an approval is received. For instance, if an input is received not indicating approval or if no input is received for a time, operation may end 530. If the electronic device 102 determines 508 that approval is received (e.g., an input is received indicating approval), the electronic device 102 determines 510 remaining battery power. For example, the electronic device 102 may use a Power Management Device (PMD) to determine 510 the remaining battery power. For instance, the electronic device 102 (e.g., authorization module 206 or evaluation module 208) requests and/or receives a measurement of or information about remaining battery 234 (e.g., power, charge, etc.) from the PMD.

The electronic device 102 may obtain 512 device information. For example, the electronic device 102 may obtain 512 (additional) device information such as settings 340, communications 342, state 344, performance history 346, usage history 348 and/or temperature 350. The electronic device 102 may obtain 512 this device information by requesting and/or receiving it from the Operating System (OS), sensors and/or memory of the electronic device 102, for example.

The electronic device 102 may evaluate 514 media information and device information. For example, the electronic device 102 (e.g., evaluation module 108) may evaluate the media information, remaining battery power and/or additional device information to determine whether the media 116 can be presented in its 116 entirety using the remaining battery power or a portion of the remaining battery power. The portion of remaining battery power may be a percentage of battery power (of battery capacity or of remaining power/charge, for example) or a portion that allows a certain amount of battery power or charge to remain before complete discharge, for example. For instance, the electronic communication device 102 may preserve at least a set number of milliamp hours (mAh) in the battery after presenting any media 116 (e.g., assuming any media 116 is presented).

In one configuration, the electronic device 102 uses one or more of media complexity 322, media resolution 324, media frame rate 326, media bit rate 328, media size 330, media duration 332, media format 338, remaining battery 334, settings 340, communications 342, state 344, performance history 346, usage history 348, temperature 350 and/or other factors 236 to determine whether the media 216 can be presented in its entirety using the remaining battery 334 power. For instance, the electronic device 102 (e.g., evaluation module 108) uses one or more of these factors to compute a presentation cost or presentation cost estimate and compares it to the remaining battery power 334, determining whether the presentation cost or estimate is greater than the remaining battery power 334 or a portion of remaining battery power 334.

In one configuration, the electronic device 102 may evaluate 514 multiple differing media 116 or media 116 versions. For example, electronic device B 114 (e.g., a media server 314) may provide differing versions of the media 116 that may be selected by the electronic device 102. For instance, differing media 116 versions may have differing media complexities 322, media resolutions 324, media frame rates 326, media bit rates 328, media sizes 330, media durations 332, media formats 338 and/or other attributes. In other words, one or more pieces or types of media information 322, 324, 326, 328, 330, 332, 338 may differ between different versions of the media 116. One or more sets (e.g., combinations) of media information 322, 324, 326, 328, 330, 332, 338 may be evaluated 514 to determine a presentation cost for each set of media information.

In one configuration, the electronic device 102 may additionally or alternatively evaluate 514 multiple differing sets of device information 334, 340, 342, 344, 346, 348, 350. For example, the electronic device 102 (e.g., evaluation module 108) may evaluate 514 multiple presentation costs for the media 116 based on differing settings 340 (e.g., at differing brightness, volume, etc.), communications 342, states 344, etc. For instance, the electronic device 102 may evaluate 514 differing sets of device information 334, 340, 342, 344, 346, 348, 350 to determine if the media 116 can be presented in its entirety with differing display brightnesses and/or volumes, assuming that the electronic device 102 is communicating at differing rates/qualities (e.g., lower rate/quality), assuming that the electronic device 102 is not multitasking (or assuming it 102 has closed a high power-consuming application, for example) and/or whether the electronic device 102 is charging (e.g., plugged into a wall outlet via the power interface 352), etc. In other words, the electronic device 102 may compute multiple presentation costs or presentation cost estimates based on the sets of differing device information (and/or the sets of differing media information, for example), to determine which of the sets, if any, would allow the media 116 to be presented in its entirety.

The electronic device 102 may optionally determine 516 a resolution. For example, the electronic device 102 may use the evaluation 514 to determine 516 a resolution for media 116 that can be presented in its entirety. In one configuration, the electronic device 102 determines the highest media resolution 324 (if multiple resolutions are available, for example) that can be played in its entirety on the remaining battery power 334 or a portion thereof. For example, selecting different resolutions 324 may be one approach for negotiating Quality of Service (QoS). For instance, an electronic device may negotiate Quality of Service (QoS) with another electronic device (e.g., base station 358, network 312, media server 314, etc.) according to media resolution based on remaining battery charge or power. It should be noted that media resolution may refer to video spatio-temporal rates (e.g., image or picture size and frame rate).

The electronic device 102 determines 518 whether to restrict access to the media 116. This determination 518 may be based on the media information, remaining battery power and/or additional device information. For example, the electronic device 102 may determine 518 whether to restrict access to the media 116 based on the evaluation 514 and/or determined resolution 516. In one configuration, the evaluation 514 and/or resolution determination 516 are included in the determination 518 whether to restrict access.

In one configuration, the electronic device 102 (e.g., authorization module 106) determines 518 to restrict access to the media 116 if the media 116 cannot be presented in its entirety with the remaining battery power or a portion of the remaining battery power. For example, if the presentation cost or estimate is greater than the remaining battery power 334 or a (specified) portion thereof, the electronic device 102 determines 518 to restrict media access. In another (more specific) configuration, the electronic device 102 determines 518 to restrict access if the media 116 cannot be presented with the remaining battery power (or a portion thereof) according to the current electronic device 102 behavior and/or according to the current media selection. For example, the electronic device 102 may determine 518 to restrict access if the media information and/or device information indicates that according to the current media selection and/or according to current electronic device 102 behavior, the media 116 could not be presented in its entirety with the remaining battery power (or a portion thereof) (e.g., even if a different version of the media 116 could be determined and/or the electronic device 102 could behave differently). In another configuration, the electronic device 102 automatically selects a media version 116 and/or electronic device 102 behavior that would allow the media 116 to be presented in its entirety. For example, the electronic device 102 may adjust settings 340, communications 342 and/or state 344 and additionally or alternatively may select media with a differing complexity 322, resolution 324, frame rate 326, bit rate 328, size 330, duration 332 and/or format 338. For instance, the electronic device 302 may lower its display 318 brightness and speaker 320 volume, lower its transmit power, close a high-power-consumption application and/or disallow pause for the duration of the media 116.

If the electronic device 102 determines 518 to restrict access, the electronic device 102 may notify 520 the user. For example, the electronic device 102 may display and/or output a message indicating that the media 116 cannot be presented on the remaining battery power (e.g., for the current electronic device 102 behavior and/or media 116 selection).

The electronic device 102 may determine 522 whether to reevaluate. For example, the electronic device 102 may display or output a message indicating that the media 116 may be presented in its entirety if the selected media 116 version were different and/or if the electronic device 102 behavior were different. For example, the message may additionally or alternatively suggest that the media 116 may be presented if the electronic device 102 were charging (e.g., “plugged in”), if a lower media 116 resolution were selected, if the display brightness were reduced, if another application were terminated, if communication power and/or speed were reduced, etc.

In one configuration, the electronic device 102 may await an input indicating whether to reevaluate (e.g., a user may plug in the electronic device 102, lower the screen brightness, etc., and/or input a command to reevaluate). In another configuration, the message asks whether a user would like the electronic device 102 to automatically make adjustments in order to allow the media 116 to be presented. If an affirmative indication is received, the electronic device 102 may adjust settings 340, communications 342 and/or state 344 and additionally or alternatively may select media with a differing complexity 322, resolution 324, frame rate 326, bit rate 328, size 330, duration 332 and/or format 338. For instance, the electronic device 302 may lower its display 318 brightness and speaker 320 volume, lower its transmit power, close a high-power-consumption application and/or disallow pause for the duration of the media 116. The electronic device 102 may thus determine 522 to reevaluate (e.g., if an indication is received to reevaluate and/or if changes in media 116 version and/or electronic device 102 behavior occur and/or are permitted to be made). If the electronic device 102 determines 522 to reevaluate, the electronic device 102 may return to determine 510 remaining battery power (and to obtain 512 device information and/or to use updated media information (such as a lower resolution), for example).

If the electronic device 102 determines not to reevaluate, it 102 may restrict 524 access. In one configuration, the electronic device 102 (e.g., authorization module 106) restricts 524 access by denying access to the media 116. For example, the electronic device 102 does not stream, download and/or present the media 116. In other configurations, the electronic device 102 (e.g., authorization module 106) restricts 524 access to the media 116 by additionally or alternatively notifying the user that there is not enough remaining battery to present the media 116, denying access to the media 116 unless it 102 receives specific authorization to present only a part of the media 116 (at a full or reduced pay-per-view price, for example) and/or denying access to the media 116 unless it 102 receives an instruction and/or determines to present another version of the media 116 (e.g., lower resolution, lower complexity, etc.) that can be presented in its entirety. After restricting 524 access, operation may end 530.

If the electronic device 102 determines 518 not to restrict access (when the media 116 can be presented in its entirety on the remaining battery 110 power or a portion thereof, for example), the electronic device 102 obtains 526 the media 116. For example, the electronic device 102 may stream or download the media 116 from electronic device B 114 using the network 112. The electronic device 102 may present 528 the media 116. For example, the electronic device 102 may display the media 116 (e.g., for videos, images, etc.) on a display on the electronic device 102. The electronic device 102 may additionally or alternatively output an acoustic signal (e.g., for audio, sounds, music, etc.) using speakers included in or headphones or other speakers attached to the electronic device 102, for example. It should be noted that in order for the media 116 to be presented 528, the media 116 may be decoded for playback, for example. After presenting 528 the media 116, operation may end 530.

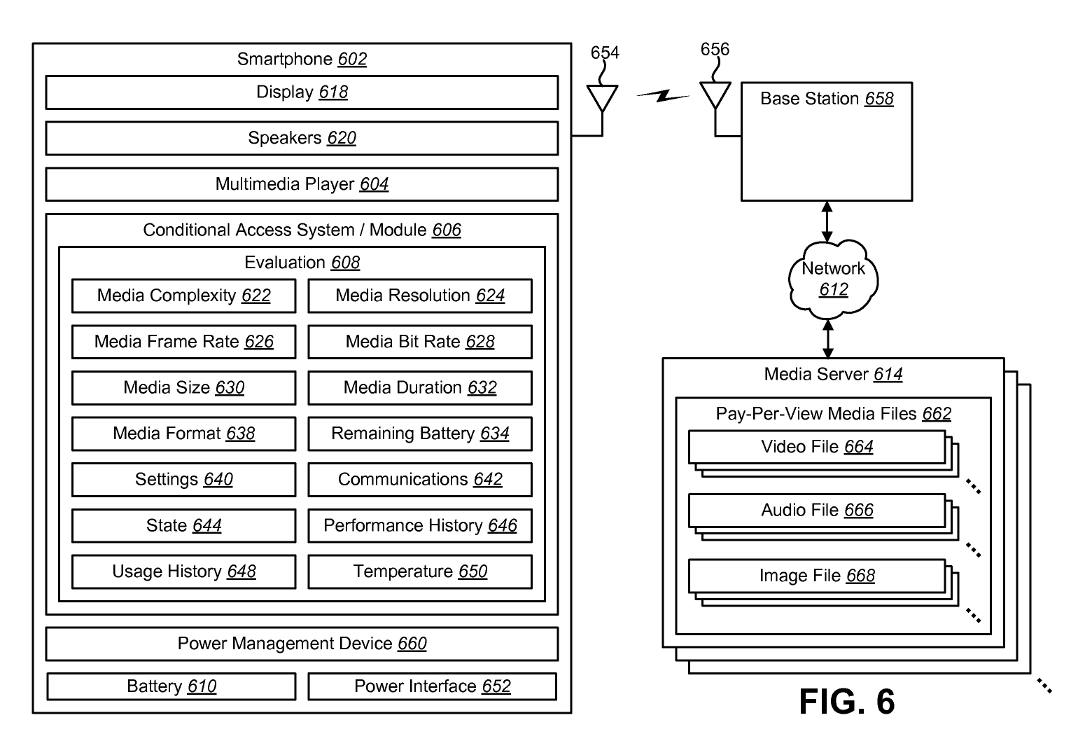

FIG. 6 is a block diagram illustrating one configuration of a smartphone 602 in which systems and methods for controlling access to media for an electronic device may be implemented. In the configuration illustrated in FIG. 6, the smartphone 602 includes a display 618, one or more speakers 620, a multimedia player 604, a conditional access system/module (CAS) 606, a power management device 660, a battery 610, a power interface 652 and one or more antennas 654. The power management device (PMD) 660 provides access to information about the battery 610 and/or power interface 652. For example, the power management device 660 provides a measurement of the remaining charge or power in the battery 610 (to the conditional access system/module 606, for example). Furthermore, the power management device 660 may provide an indication of power interface 652 status (e.g., whether the power interface is receiving a charge or power from an external power source). The battery 610 generally provides power to the smartphone 602. The power interface 652 may be used to charge the battery 610. For example, the power interface 652 may include a port that allows the smartphone 602 to be connected to an external power source (e.g., wall outlet, car power adapter, etc.). The battery 610 may be charged or charging when the power interface 652 is connected to an external power source.

The smartphone 602 communicates with one or more media servers 614 using a base station 658 and a network 612. For example, the smartphone 602 and the base station 658 communicate by transmitting and/or receiving electromagnetic signals using their respective antennas 654, 656. The base station 658 may have one or more antennas 656. The base station 658 may communicate with the one or more media servers 614 over the network 612. For example, the base station 658 may relay one or more messages from the smartphone to the one or more media servers 614 and vice-versa.

The one or more media servers 614 include one or more pay-per-view media files 662, such as video files 664, audio files 666 and/or image files 668. A user's account is charged to access the pay-per-view media files 662. In one configuration, a user's account is automatically charged when pay-per-view media files 662 are accessed by the smartphone 602. In another configuration, access will not be allowed unless payment is received or in process (e.g., a user could provide a credit card number or information for an electronic check/withdrawal, etc.). Examples of video files 664 include sporting events (e.g., boxing, fighting, soccer, basketball, football, etc.) and/or movies, etc. Examples of audio files 666 include music, songs, audio that corresponds to a video, voice recordings and/or other sounds. Examples of image files 668 include photographs and/or artwork, etc. The one or more media servers 614 may provide access to the one or more pay-per-view media files 662 when the conditional access system/module (CAS) 606 sends a message to the one or more media servers 614 indicating that the smartphone 602 is permitted to access the pay-per-view media files 662. When access to one or more pay-per-view media files 662 is provided by a media server 614, the smartphone 602 presents them 662 using the multimedia player 604 and the display 618 and/or speakers 620.

The conditional access system/module (CAS) 606 controls the smartphone's 602 access to the media. For example, the conditional access system/module 606 may deny the smartphone 602 access to the pay-per-view media files 662 if a prior bill hasn't been paid or if a correct password is not entered. Additionally or alternatively, the conditional access system/module 606 may deny the smartphone 602 access to a pay-per-view media file 662 if not enough power or charge remains in the battery 610 to present an entire pay-per-view media file 662 (e.g., a video file 664, audio file 666 or image file 668).

The conditional access system/module 606 includes an evaluation module 608, which it 606 may use to control access to the pay-per-view media files 662 based on remaining battery 610 power. For example, the evaluation module 608 includes or uses information such as media complexity 622, media resolution 624, media frame rate 626, media bit rate 628, media size 630, media duration 632, media format 638, remaining battery power 634, settings 640, communications 642, state 644, performance history 646, usage history 648 and/or temperature 650. One or more of these factors 622, 624, 626, 628, 630, 632, 638, 634, 640, 642, 644, 646, 648, 650 may be used to determine or project the amount of power or charge from the battery 610 that is needed to receive and/or present a pay-per-view media file 662 (e.g., a video file 664, an audio file 666 or an image file 668).

The smartphone 602 may obtain the information in the evaluation module 608 locally (e.g., from the smartphone 602 memory) and/or from another electronic device on the network 612. In one configuration, the smartphone 602 periodically receives information about the pay-per-view media files 662. For instance, the smartphone 602 may periodically download and store playlists and pay-per-view media files 662 metadata (including some or all of the media information 622, 624, 626, 628, 630, 632, 638) from the media server 614 or from another electronic device on the network 612. In another configuration, the smartphone 602 requests and/or receives information (e.g., some or all of the media information 622, 624, 626, 628, 630, 632, 638) from the media server 614 or from another electronic device on the network 612 about the pay-per-view media files 662.

The smartphone 602 may also obtain information (e.g., device information 634, 640, 642, 644, 646, 648, 650) relating to the smartphone 602. For example, the smartphone 602 requests a measurement of remaining battery power 634 from the Power Management Device (PMD) 660. Settings 640, communications 642, state 644, performance history 646, usage history 648 and/or temperature 650 may be obtained, for example, by querying an Operating System (OS), sensors and/or memory or records (for performance history 646 and/or usage history 648, for example) on the smartphone 602.

The evaluation module 608 uses one or more pieces of information (e.g., media information and/or device information) to determine whether the smartphone 602 can present one or more pay-per-view media files 662 (e.g., a video file 664, an audio file 666, an image file 668, etc.) in its entirety on the remaining battery 610 power or a portion of the remaining battery 610 power. For example, the evaluation module 608 uses media complexity 622, media resolution 624, media frame rate 626, media bit rate 628, media size 630, media duration 632, media format 638, remaining battery 634, settings 640, communications 642, state 644, performance history 646, usage history 648, and/or temperature 650 to compute a presentation cost. The presentation cost indicates an amount or estimate of battery 610 power required to present a pay-per-view media file 662 (in mAh, for example). In one configuration, the evaluation module 608 compares the presentation cost to the remaining battery power 634. If the amount or estimate of battery 610 power required to present the pay-per-view media files 662 is greater than the remaining battery power 634 or an amount of remaining battery power 634, the evaluation module 608 determines that the pay-per-view media file 662 cannot be presented in its entirety on the remaining battery power 634.

The conditional access system/module 606 uses the determination made by the evaluation module 608 to control the smartphone's 602 access to pay-per-view media files 662. In one configuration, the conditional access system/module 606 restricts the smartphone's 602 access to the pay-per-view media files 662 (e.g., video files 664, audio files 666 and/or image files 668) when the evaluation module 608 determines that there is not enough remaining battery power 634 to present the pay-per-view media file 662 in its entirety. In one configuration, the conditional access system/module 606 restricts the smartphone's 602 access to the pay-per-view media files 662 by denying access to the pay-per-view media files 662 (e.g., not allowing the smartphone 602 to download, stream and/or present the pay-per-view media files 662). In other configurations, the conditional access system/module 606 restricts access to a pay-per-view media file 662 by additionally or alternatively notifying the user that there is not enough remaining battery 634 to present the pay-per-view media file 662, denying access to the pay-per-view media file 662 unless it receives specific authorization to present only a part of the pay-per-view media file 662 (at a full or reduced pay-per-view price, for example) and/or denying access to the pay-per-view media file 662 unless it 602 receives an instruction and/or determines to present another version of the pay-per-view media file 662 (e.g., lower resolution 624, lower complexity 622, etc.) that can be presented in its entirety.

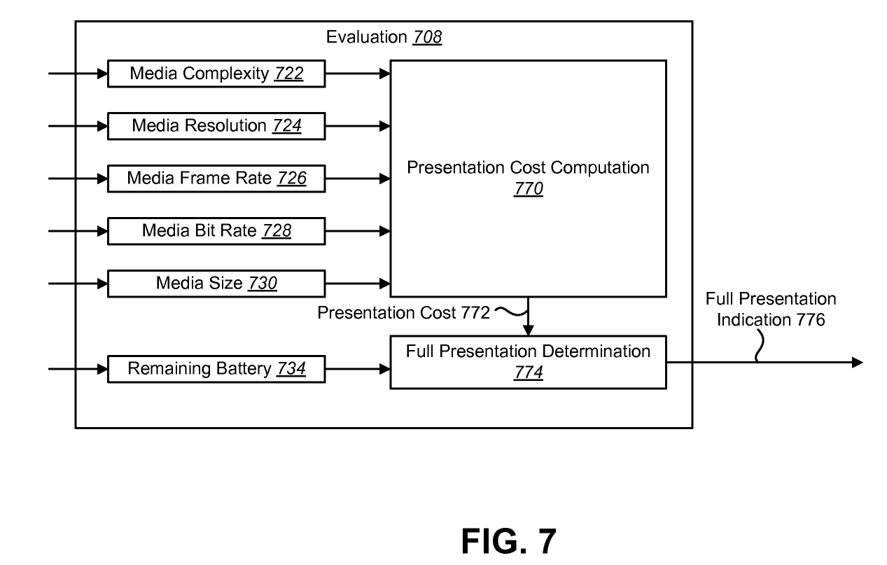

FIG. 7 is a block diagram illustrating one configuration of an evaluation module 708 that may be used for controlling access to media for an electronic device. The evaluation module 708 may receive, include and/or use multiple pieces of information. For example, the evaluation module 708 may use one or more of media complexity 722, media resolution 724, media frame rate 726, media bit rate 728, media size 730 and/or remaining battery 734.

The evaluation module 708 includes a presentation cost computation module 770 and a full presentation determination module 774. The presentation cost computation module 770 computes a presentation cost 772 or a presentation cost estimate 772. For example, the presentation cost computation module 770 uses one or more of the media complexity 722, media resolution 724, media frame rate 726, media bit rate 728 and/or media size 730 to compute a presentation cost 772 or presentation cost estimate 772. For instance, media complexity 722, media resolution 724, media frame rate 726, media bit rate 728 and/or media size 730 may be used to determine an amount of processing and/or an amount of power or charge needed to present the media 116. This amount of charge or power is the presentation cost 772, which indicates the amount or an estimate of the amount of power or charge needed to present the media 116 (e.g., a media file) in its entirety.

The full presentation determination module 774 compares the remaining battery 734 with the presentation cost 772 in order to determine a full presentation indication 776. This is illustrated in Equation (1).

$$\{ \begin{matrix}B \geq C -> F \\ B < C -> \overline{F}\end{matrix} \qquad ( 1 )$$

In Equation (1), B is the remaining battery 734, C is the presentation cost 772 and F is the full presentation indication 776. In other words, if the remaining battery 734 power or charge is greater than or equal to the presentation cost 772, the full presentation indication 776 indicates that enough battery power or charge remains to present the media 116 in its entirety. However, if the remaining battery 734 is less than the presentation cost 772, the full presentation indication 776 indicates that not enough battery power or charge remains to present the media 116 in its entirety. The full presentation indication 776 may be provided to the authorization module 106 for use in determining whether the electronic device 102 is authorized to access the media 116.

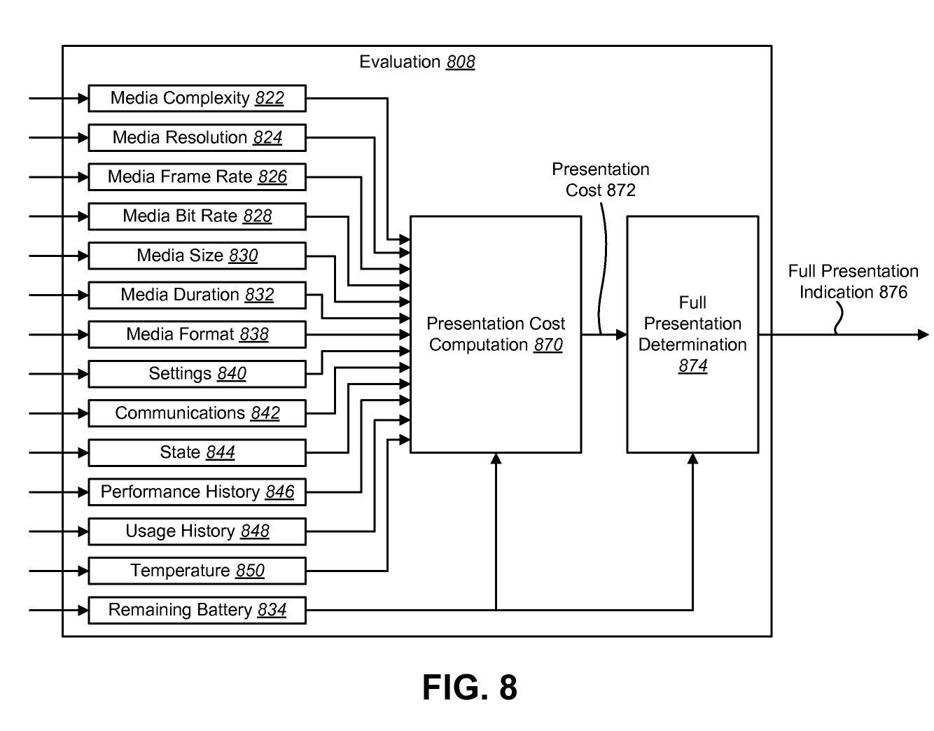

FIG. 8 is a block diagram illustrating another configuration of an evaluation module 808 that may be used for controlling access to media for an electronic device. The evaluation module 808 may receive, include and/or use multiple pieces of information. For example, the evaluation module 808 may use one or more of media complexity 822, media resolution 824, media frame rate 826, media bit rate 828, media size 830, media duration 832, media format 838, settings 840, communications 842, state 844, performance history 846, usage history 848, temperature 850 and/or remaining battery 834.

The evaluation module 808 includes a presentation cost computation module 870 and a full presentation determination module 874. The presentation cost computation module 870 computes a presentation cost 872 or a presentation cost estimate 872. For example, the presentation cost computation module 870 uses one or more of media complexity 822, media resolution 824, media frame rate 826, media bit rate 828, media size 830, media duration 832, media format 838, settings 840, communications 842, state 844, performance history 846, usage history 848, temperature 850 and/or remaining battery 834 to compute a presentation cost 872 or presentation cost estimate 872. For instance, media complexity 822, media resolution 824, media frame rate 826, media bit rate 828, media size 830, media duration 832, media format 838, settings 840, communications 842, state 844, performance history 846, usage history 848, temperature 850 and/or remaining battery 834 may be used to determine a presentation cost 872 (or presentation cost estimate 872, for example) or an amount of power or charge needed to present (e.g., receive and display, output, etc.) the media 116 (e.g., a media file) in its entirety.

The full presentation determination module 874 compares the remaining battery 834 with the presentation cost 872 in order to determine a full presentation indication 876. This is illustrated as shown in Equation (1) above. In other words, if the remaining battery 834 power or charge is greater than or equal to the presentation cost 872, the full presentation indication 876 indicates that enough battery power or charge remains to present the media 116 in its entirety. However, if the remaining battery 834 is less than the presentation cost 872, the full presentation indication 876 indicates that not enough battery power or charge remains to present the media 116 in its entirety. The full presentation indication 876 may be provided to the authorization module 106 for use in determining whether the electronic device 102 is authorized to access the media 116.

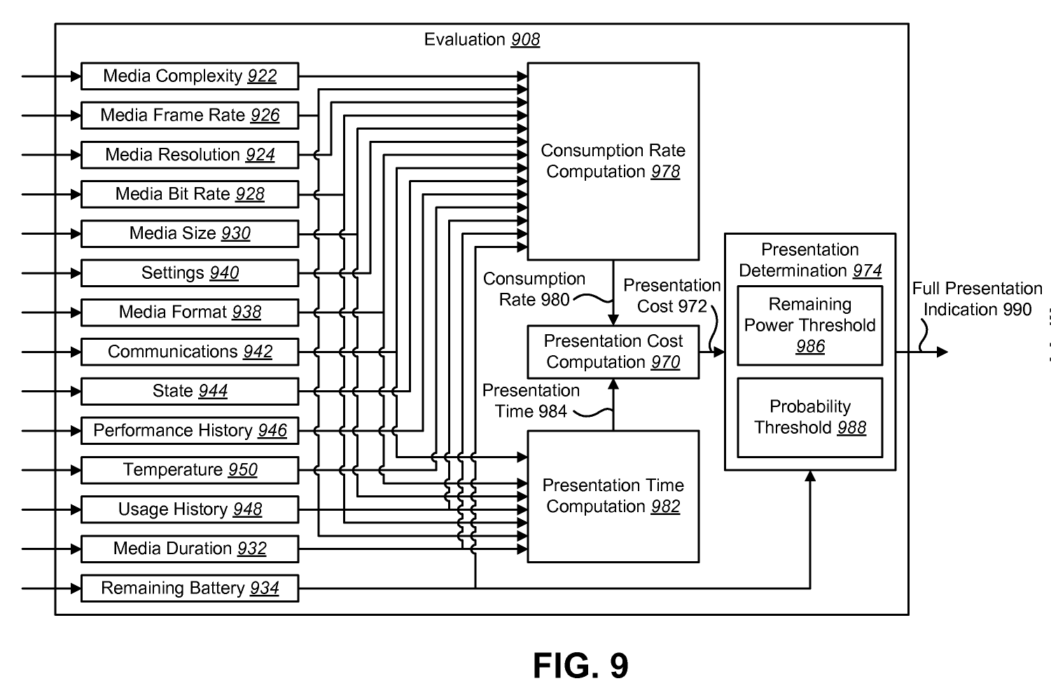

FIG. 9 is a block diagram illustrating another configuration of an evaluation module 908 that may be used for controlling access to media for an electronic device. The evaluation module 908 may receive, include and/or use multiple pieces of information. For example, the evaluation module 908 may use one or more of media complexity 922, media resolution 924, media frame rate 926, media bit rate 928, media size 930, media duration 932, media format 938, settings 940, communications 942, state 944, performance history 946, usage history 948, temperature 950 and/or remaining battery 934.

The evaluation module 908 includes a consumption rate computation module 978, a presentation time computation module 982, a presentation cost computation module 970 and/or a presentation determination module 974. The consumption rate computation module 978 may use media complexity 922, media resolution 924, media frame rate 926, media bit rate 928, media size 930, media duration 932, media format 938, settings 940, communications 942, state 944, performance history 946, usage history 948, temperature 950 and/or remaining battery 934 to compute a consumption rate 980. The consumption rate 980 may be a consumption rate estimate 980.

The consumption rate 980 may indicate a rate of power or charge consumption, for example. In one configuration, the consumption rate 980 is an estimated power or charge consumption rate (e.g., an estimated average rate) over a period of time (e.g., over the media duration 932 or longer). In another configuration, the consumption rate 980 indicates a (projected) consumption rate 980 that may vary over time based on the media information 922, 924, 926, 928, 930, 932, 938 and/or the device information 934, 940, 942, 944, 946, 950, 948. For example, the consumption rate 980 may vary depending on the amount of remaining battery 934 charge or power and the device temperature 950. More specifically, a battery 110 may discharge more rapidly (at a higher rate) when operating at a higher temperature and/or when there is a smaller amount of charge remaining.

Furthermore, for instance, the consumption rate 980 may be higher when the display brightness is set higher and/or speaker volume is higher (according to the settings 940, for example), when multiple processes are operating at the same time (according to the state 944, for example), when the media complexity 922 is higher, when the media frame rate 926 is higher, when the media resolution 924 is higher, when the media bit rate 928 is higher, when the media format 938 requires more processing and/or when communications 942 are consuming more power (e.g., for higher antenna gain, etc.), etc. The performance history 946 and/or usage history 948 may also be used to estimate or project the consumption rate 980. For example, the usage history 948 may indicate whether the electronic device 102 tends to run several applications during media 116 presentation or not. The performance history 946 may indicate how the battery 110 has been performing recently. Many other aspects of usage history 948 and/or performance history 946 may be used.

The presentation time computation module 982 may be used to compute (e.g., determine or estimate) a presentation time 984. The presentation time 984 may indicate an amount of time (or an estimated amount of time) used to present the media 116. The presentation time computation module 982 may use one or more of the media frame rate 926, the media bit rate 928, the media size 930, the media format 938, the communications 942, the usage history 948 and/or the media duration 932, for example. For instance, the media frame rate 926 and/or the media bit rate 928 may be used in conjunction with the media size 930 to compute a length of time for presentation. The media duration 932 may also indicate a length of time for presentation.

The communications 942 may be used to estimate streaming delays in presentation, for example. For instance, if the electronic device 102 is receiving a weak signal, the streaming rate may be slowed, thereby extending the presentation time 984. Usage history 948 may indicate whether an electronic device 102 tends to pause presentation of the media 116. Additional or alternative factors may be used to compute the presentation time 984. For example, performance history 946 may indicate that the electronic device 102 has traditionally had delays in receiving and/or decoding media 116 (e.g., because of a poor signal and/or multitasking). Thus, the presentation time computation module 982 may compute a presentation time 984. The presentation time 984 may be a projected estimate for the amount of time that the media will be presented for, for example.

The consumption rate 980 and the presentation time 984 may be used by the presentation cost computation module 970 to compute or determine a presentation cost 972. The presentation cost 972 may be a projected estimate of the amount of power or charge needed to present the media 116 in its entirety. In a configuration where the consumption rate 980 is an average rate, the presentation cost computation module 970 may multiply the consumption rate 980 by the presentation time 984 in order to compute the presentation cost 972. In a configuration where the consumption rate 980 is a projection that may vary over time, the presentation cost computation module 970 may compute an integral of the consumption rate 980 over the range given by the presentation time 984 or it 970 may compute an approximation of the integral in order to produce a presentation cost 972. In one configuration, for example, the consumption rate 980 is defined in terms of current (e.g., in mA/second) and the computed presentation cost 972 is expressed in terms of mAh. In other configurations, the consumption rate 980 and/or presentation cost 972 may be defined using different units.

The presentation determination module 974 may determine a full presentation indication 990 based on the presentation cost 972 and/or the remaining battery 934 (power or charge, for example). In one configuration, the presentation determination module 974 may compare the presentation cost 972 with the remaining battery 934 to determine the full presentation indication 990 as illustrated in Equation (1) above. In another configuration, the presentation determination module 974 may use a remaining power threshold 986. The remaining power threshold 986 may require at least a certain amount of power or charge to be remaining after the media 116 is presented (assuming that the media 116 is presented, for example). This may be illustrated as expressed in Equation (2).

$$\{ \begin{matrix}B - T \geq C -> F \\ B - T < C -> \overline{F}\end{matrix} \qquad ( 2 )$$

In Equation (2), B is the remaining battery 934, T is the remaining power threshold 986, C is the presentation cost 972 and F is the full presentation indication 990. Thus, if the remaining battery power 934 minus the threshold 986 is greater than or equal to the presentation cost, the full presentation indication 990 indicates that the media 116 may be presented in its entirety within an amount of the remaining battery 934 (power or charge, etc.). However, if the remaining battery power 934 minus the threshold 986 is less than the presentation cost, the full presentation indication 990 indicates that the media 116 may not be presented in its entirety within an amount of the remaining battery 934 (power or charge, etc.). It should be noted that the approach illustrated in Equation (2) may additionally or alternatively be used in conjunction with the configurations illustrated in FIGS. 7 and 8.

The presentation determination module 974 may additionally or alternatively use a probability threshold 988. The probability threshold 988 requires that the media 116 be presented in its entirety with a minimum likelihood. For example, a probability that the media 116 will be presented in its entirety may be computed based on one or more of the factors 922, 924, 926, 928, 930, 932, 934, 938, 940, 942, 944, 946, 948, 950 described above. If the media 116 can be presented in its entirety with a probability greater than or equal to the probability threshold 988 (e.g., 95%), the full presentation indication 990 may indicate that the media 116 may be presented in its entirety within the remaining battery 934 (power, charge, etc.) or an amount thereof. If the media 116 can be presented in its entirety with a probability less than or equal to the probability threshold 988 (e.g., 95%), the full presentation indication 990 may indicate that the media 116 may not be presented in its entirety within the remaining battery 934 (power, charge, etc.) or an amount thereof.

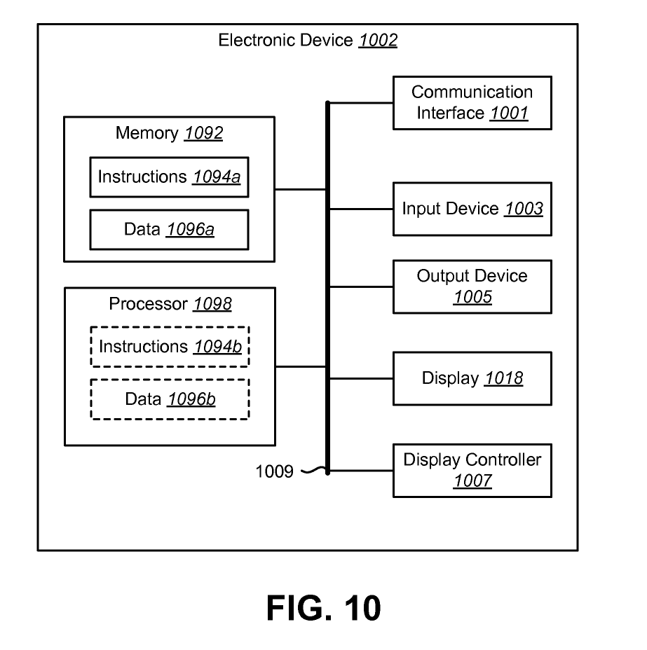

FIG. 10 illustrates various components that may be utilized in an electronic device 1002. The illustrated components may be located within the same physical structure or in separate housings or structures. The electronic devices 102, 114, 202, 214 discussed above may be configured similarly to the electronic device 1002. The electronic device 1002 includes a processor 1098. The processor 1098 may be a general purpose single- or multi-chip microprocessor (e.g., an ARM), a special purpose microprocessor (e.g., a digital signal processor (DSP)), a microcontroller, a programmable gate array, etc. The processor 1098 may be referred to as a central processing unit (CPU). Although just a single processor 1098 is shown in the electronic device 1002 of FIG. 10, in an alternative configuration, a combination of processors (e.g., an ARM and DSP) could be used.

The electronic device 1002 also includes memory 1092 in electronic communication with the processor 1098. That is, the processor 1098 can read information from and/or write information to the memory 1092. The memory 1092 may be any electronic component capable of storing electronic information. The memory 1092 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1096a and instructions 1094a may be stored in the memory 1092. The instructions 1094a may include one or more programs, routines, sub-routines, functions, procedures, etc. The instructions 1094a may include a single computer-readable statement or many computer-readable statements. The instructions 1094a may be executable by the processor 1098 to implement the methods 400, 500 that were described above. Executing the instructions 1094a may involve the use of the data 1096a that is stored in the memory 1092. FIG. 10 shows some instructions 1094b and data 1096b being loaded into the processor 1098.

The electronic device 1002 may also include one or more communication interfaces 1001 for communicating with other electronic devices. The communication interfaces 1001 may be based on wired communication technology, wireless communication technology, or both. Examples of different types of communication interfaces 1001 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The electronic device 1002 may also include one or more input devices 1003 and one or more output devices 1005. Examples of different kinds of input devices 1003 include a keyboard, mouse, microphone, remote control device, button, joystick, trackball, touchpad, lightpen, etc. Examples of different kinds of output devices 1005 include a speaker, printer, etc. One specific type of output device which may be typically included in an electronic device 1002 is a display device 1018. Display devices 1018 used with configurations disclosed herein may utilize any suitable image projection technology, such as a cathode ray tube (CRT), liquid crystal display (LCD), light-emitting diode (LED), gas plasma, electroluminescence, or the like. A display controller 1007 may also be provided, for converting data stored in the memory 1092 into text, graphics, and/or moving images (as appropriate) shown on the display device 1018.

The various components of the electronic device 1002 may be coupled together by one or more buses, which may include a power bus, a control signal bus, a status signal bus, a data bus, etc. For simplicity, the various buses are illustrated in FIG. 10 as a bus system 1009. It should be noted that FIG. 10 illustrates only one possible configuration of an electronic device 1002. Various other architectures and components may be utilized.

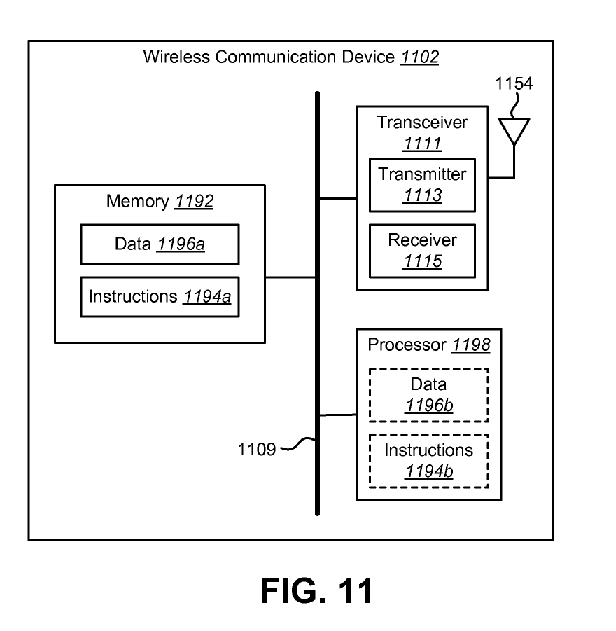

FIG. 11 illustrates certain components that may be included within a wireless communication device 1102. The wireless communication device 302 described above may be configured similarly to the wireless communication device 1102 that is shown in FIG. 11. The wireless communication device 1102 includes a processor 1198. The processor 1198 may be a general purpose single- or multi-chip microprocessor (e.g., an ARM), a special purpose microprocessor (e.g., a digital signal processor (DSP)), a microcontroller, a programmable gate array, etc. The processor 1198 may be referred to as a central processing unit (CPU). Although just a single processor 1198 is shown in the wireless communication device 1102 of FIG. 11, in an alternative configuration, a combination of processors (e.g., an ARM and DSP) could be used.

The wireless communication device 1102 also includes memory 1192 in electronic communication with the processor 1198 (i.e., the processor 1198 can read information from and/or write information to the memory 1192). The memory 1192 may be any electronic component capable of storing electronic information. The memory 1192 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1196a and instructions 1194a may be stored in the memory 1192. The instructions 1194a may include one or more programs, routines, sub-routines, functions, procedures, etc. The instructions 1194a may include a single computer-readable statement or many computer-readable statements. The instructions 1194a may be executable by the processor 1198 to implement the methods 400, 500 that were described above. Executing the instructions 1194a may involve the use of the data 1196a that is stored in the memory 1192. FIG. 11 shows some instructions 1194b and data 1196b being loaded into the processor 1198.

The wireless communication device 1102 may also include a transmitter 1113 and a receiver 1115 to allow transmission and reception of signals between the wireless communication device 1102 and a remote location (e.g., a base station or other wireless communication device). The transmitter 1113 and receiver 1115 may be collectively referred to as a transceiver 1111. An antenna 1154 may be electrically coupled to the transceiver 1111. The wireless communication device 1102 may also include (not shown) multiple transmitters, multiple receivers, multiple transceivers and/or multiple antenna.

The various components of the wireless communication device 1102 may be coupled together by one or more buses, which may include a power bus, a control signal bus, a status signal bus, a data bus, etc. For simplicity, the various buses are illustrated in FIG. 11 as a bus system 1109.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. An electronic device for controlling access to media, comprising:
a processor;
memory in electronic communication with the processor;
instructions stored in the memory, the instructions being executable to:
obtain media information;
determine remaining battery power;
determine whether to restrict access to the media based on the media information and the remaining battery power;
restrict access to the media if it is determined to restrict access; and
present the media on the electronic device if it is determined not to restrict access.

2. The electronic device of claim 1, wherein restricting access to the media comprises denying access to the media.

3. The electronic device of claim 1, wherein restricting access to the media comprises outputting a message indicating that there is not enough remaining battery power to present the media.

4. The electronic device of claim 1, wherein restricting access to the media comprises denying access to the media unless an authorization is received by the electronic device to present only a part of the media.

5. The electronic device of claim 1, wherein restricting access to the media comprises denying access to the media unless the electronic device determines to present another version of the media that can be presented in its entirety.

6. The electronic device of claim 1, wherein the media is pay-per-view media.

7. The electronic device of claim 6, wherein payment is required to access the pay-per-view media.

8. The electronic device of claim 6, wherein the pay-per-view media is on-demand.

9. The electronic device of claim 6, wherein the pay-per-view media is scheduled.

10. The electronic device of claim 1, wherein obtaining media information comprises:
sending a request for the media information; and
receiving the media information.

11. The electronic device of claim 1, wherein the electronic device is a wireless communication device.

12. The electronic device of claim 1, wherein the instructions are further executable to obtain the media if it is determined not to restrict access.

13. The electronic device of claim 1, wherein the instructions are further executable to determine a resolution based on the media information and the remaining battery power.

14. The electronic device of claim 1, wherein the media information comprises media complexity.

15. The electronic device of claim 1, wherein the media information comprises media resolution, media size, media duration and media format.

16. The electronic device of claim 1, wherein the instructions are further executable to obtain device information.

17. The electronic device of claim 16, wherein the device information comprises settings, communications, state, performance history, usage history and temperature.

18. The electronic device of claim 1, wherein it is determined to restrict access to the media if the media cannot be presented in its entirety on the remaining battery power.

19. The electronic device of claim 1, wherein it is determined to restrict access to the media if the media cannot be presented in its entirety on an amount of remaining battery power.

20. The electronic device of claim 1, wherein the media comprises one of the group consisting of a video file, an audio file and an image file.

21. A method for controlling access to media, comprising:
obtaining media information;
determining remaining battery power;
determining, on an electronic device, whether to restrict access to the media based on the media information and the remaining battery power;
restricting, by the electronic device, access to the media if it is determined to restrict access; and
presenting the media on the electronic device if it is determined not to restrict access.

22. The method of claim 21, wherein restricting access to the media comprises denying access to the media.

23. The method of claim 21, wherein restricting access to the media comprises outputting a message indicating that there is not enough remaining battery power to present the media.

24. The method of claim 21, wherein restricting access to the media comprises denying access to the media unless an authorization is received by the electronic device to present only a part of the media.

25. The method of claim 21, wherein restricting access to the media comprises denying access to the media unless the electronic device determines to present another version of the media that can be presented in its entirety.

26. The method of claim 21, wherein the media is pay-per-view media.

27. The method of claim 26, wherein payment is required to access the pay-per-view media.

28. The method of claim 26, wherein the pay-per-view media is on-demand.

29. The method of claim 26, wherein the pay-per-view media is scheduled.

30. The method of claim 21, wherein obtaining media information comprises:
sending a request for the media information; and
receiving the media information.

31. The method of claim 21, wherein the electronic device is a wireless communication device.

32. The method of claim 21, further comprising obtaining the media if it is determined not to restrict access.

33. The method of claim 21, further comprising determining a resolution based on the media information and the remaining battery power.

34. The method of claim 21, wherein the media information comprises media complexity.

35. The method of claim 21, wherein the media information comprises media resolution, media size, media duration and media format.

36. The method of claim 21, further comprising obtaining device information.

37. The method of claim 36, wherein the device information comprises settings, communications, state, performance history, usage history and temperature.

38. The method of claim 21, wherein it is determined to restrict access to the media if the media cannot be presented in its entirety on the remaining battery power.

39. The method of claim 21, wherein it is determined to restrict access to the media if the media cannot be presented in its entirety on an amount of remaining battery power.

40. The method of claim 21, wherein the media comprises one of the group consisting of a video file, an audio file and an image file.

41. A computer-program product for controlling access to media, the computer-program product comprising a non-transitory tangible computer-readable medium having instructions thereon, the instructions comprising:
code for causing an electronic device to obtain media information;
code for causing the electronic device to determine remaining battery power;
code for causing the electronic device to determine whether to restrict access to the media based on the media information and the remaining battery power;
code for causing the electronic device to restrict access to the media if it is determined to restrict access; and
code for causing the electronic device to present the media on the electronic device if it is determined not to restrict access.

42. The computer-program product of claim 41, wherein the media is pay-per-view media.

43. The computer-program product of claim 41, wherein the instructions further comprise code for causing the electronic device to determine a resolution based on the media information and the remaining battery power.

44. The computer-program product of claim 41, wherein the media information comprises media complexity.

45. The computer-program product of claim 41, wherein it is determined to restrict access to the media if the media cannot be presented in its entirety on the remaining battery power.

46. An apparatus for controlling access to media, comprising:
means for obtaining media information;
means for determining remaining battery power;
means for determining whether to restrict access to the media based on the media information and the remaining battery power;
means for restricting access to the media if it is determined to restrict access; and
means for presenting the media on the apparatus if it is determined not to restrict access.

47. The apparatus of claim 46, wherein the media is pay-per-view media.

48. The apparatus of claim 46, further comprising means for determining a resolution based on the media information and the remaining battery power.

49. The apparatus of claim 46, wherein the media information comprises media complexity.

50. The apparatus of claim 46, wherein it is determined to restrict access to the media if the media cannot be presented in its entirety on the remaining battery power.
